(19) United States
(12) Patent Application Publication
(10) Pub. No.: US 2026/0146213 A1
(43) Pub. Date: May 28, 2026

(54) MILD AND SELF-PRESERVED CONCENTRATED LIQUID DETERGENTS

(71) Applicant: Henkel AG & Co. KGaA, Duesseldorf (DE)

(72) Inventors: Daniel Thomas Piorkowski, Fairfield, CT (US); Brian Alan Warren, Louisville, KY (US)

(21) Appl. No.: 19/383,226

(22) Filed: Nov. 7, 2025

Related U.S. Application Data
(60) Provisional application No. 63/724,588, filed on Nov. 25, 2024.

(51) Int. Cl. C11D 1/831; C11D 1/14; C11D 1/22; C11D 1/72; C11D 3/20

(52) U.S. Cl. CPC C11D 1/831; C11D 3/201; C11D 3/2079; C11D 1/146; C11D 1/22; C11D 1/72

(57) ABSTRACT

A self-preserved liquid detergent composition useful for laundry applications is disclosed. The liquid detergent composition comprises at least one non-aqueous solvent; at least one nonionic surfactant; at least one anionic surfactant; a C₂₋₃ alkanol; and water in an amount effective to produce a water activity of about 0.55 to about 0.8, thus enabling it to be self-preserved. Significantly, the liquid detergent composition does not contain any of the following (i) a preservative and (ii) a buffer.

This application claims benefit of priority to U.S. Provisional Patent Application Ser. No. 63/724,588 filed on Nov. 25, 2024, the entire contents of which are incorporated herein by reference.

### FIELD

The disclosure is directed to a self-preserved liquid detergent composition that does not contain preservatives or buffers.

### BACKGROUND

Mildness, which relates to the reduction of skin irritation, is a significant consumer need and driver for laundry detergent purchase. Current commercially available laundry detergents include formulations free of dyes and perfumes, which can cause skin irritation. Other causes of skin irritation in laundry detergents include certain surfactants, preservatives, and stabilizers such as propylene glycol. A variety of test methods as described, for example, in U.S. Published Patent Application No. 2018/0016523 are used to evaluate skin irritancy in laundry detergent use settings. Such methods include the Zein test as known in the art, which measures skin irritancy potential by determining the extent of denaturation of the Zien corn protein after exposure to a surfactant, as would be found in laundry detergents, for a given period of time. Another test to measure the skin irritancy is the corneosufametry (CSM) test as known in the art which is a non-invasive test quantitative test that measures the interaction between surfactants and human stratum corneum. Still another method to assess skin irritancy is the cytokine test as known in the art, which measures the cytokine release of representative human skin models in response to a surfactant-containing formulation. The aggregate of such test scores can be used to determine the mildness of the laundry detergent for the consumer.

Typically present in laundry detergents are preservatives, such as isothiazolinones including such compounds as methylisothiazolinone (MIT), benzisothiazolinone (BIT) and chloromethylisothiazolinone (CIT), which are added to forestall proliferation of bacteria, yeast and/or mold that could otherwise attend the formulation. However, preservatives can be sensitizing and cause skin irritation. Included among common surfactants used in laundry detergents are linear alkylbenzene sulfonates (LAS). The LAS are a class of anionic surfactants that are known to be advantageously biodegradable, but they are not as mild a surfactant as desired. Stabilizers are often also used in laundry detergents to keep the ingredients from separating. A commonly employed stabilizer is propylene glycol (PG), which compound can cause skin irritation and allergic reactions.

There is thus a need for a detergent composition does not contain preservatives or buffers, is of improved mildness, is self-preserved, and preferably contains less LAS and less, and even more preferably, contains no LAS and/or no PG.

### SUMMARY

A self-preserved liquid detergent composition useful for laundry applications is provided. The self-preserved liquid detergent composition of the disclosure does not contain any of the following: (i) a preservative and (ii) a buffer. In one embodiment, the liquid detergent composition comprises up to about 5 wt % LAS, or up to about 5 wt % PG, or both up about 5 wt % LAS and separately up to about 5 wt % PG. The liquid detergent composition of the disclosure is self-preserved by comprising an amount of water sufficient to provide a water activity of between about 0.55 to about 0.8, at which available water level mold, yeast, and bacteria cannot survive. In one embodiment, the detergent composition of the disclosure is a concentrated liquid detergent and is not a unit dose product wherein the detergent composition is encapsulated in a small container typically made of polyvinyl acetate (PVA) film. In this liquid detergent embodiment, glycerin can be employed since otherwise unwanted interactions of glycerin with the encapsulating unit dose film is not a concern. The ability to use glycerin assists in maintaining the water activity at the target level of between about 0.55 to about 0.8. Preservatives which are absent from the self-preserved liquid detergent composition include those known in the art such as without limitation isothiazolinones, including methylisothiazolinone, benzisothiazolinone, chloromethylisothiazolinone and the like. In one practice, the liquid detergent composition of the disclosure is a concentrate that is about 2 to about 4 times more concentrated than known standard detergents, e.g. those that are 1.5 fluid ounces per dose.

In one aspect, the disclosure provides a self-preserved liquid detergent composition useable as a non-unit dose embodiment. In one embodiment, the self-preserved liquid detergent composition comprises at least one non-aqueous solvent; at least one nonionic surfactant; at least one anionic surfactant; a C₂₋₃ alkanol; and water in an amount effective to produce a water activity of about 0.55 to about 0.8, wherein the liquid detergent composition does not contain any of the following (i) a preservative, and (ii) a buffer.

In other embodiments, the self-preserved liquid detergent composition consists essentially of at least one non-aqueous solvent; at least one nonionic surfactant; at least one anionic surfactant; a C₂₋₃ alkanol; and water in an amount effective to produce a water activity of about 0.55 to about 0.8, wherein the liquid detergent composition does not contain any of the following (i) a preservative, and (ii) a buffer.

In yet further embodiments, the liquid detergent composition consists of at least one non-aqueous solvent; at least one nonionic surfactant; at least one anionic surfactant; a C₂₋₃ alkanol; and water in an amount effective to produce a water activity of about 0.55 to about 0.8, wherein the liquid detergent composition does not contain any of the following (i) a preservative, and (ii) a buffer.

In various embodiments the water activity is between about 0.65 to about 0.75; in other embodiments the water activity is between about 0.66 to about 0.7.

In select embodiments herein the water is present at about 10 wt % to about 30 wt %, or water is present at about 15 wt % to about 25 wt %, or water is present at about 20 wt % based on the total weight of the liquid detergent composition.

In the embodiments herein the non-aqueous solvent is present in some practices at about 25 wt % to about 45 wt %; at about 30 wt % to about 40 wt %; and at about 35 and 36 wt % based on the total weight of the liquid detergent composition. In one practice, the non-aqueous solvent is glycerin. In some embodiments, the non-aqueous solvent further comprises a polyethylene glycol in addition to glycerin.

In some embodiments herein the C₂₋₃ alkanol is branched or linear and includes e.g. ethanol and isopropyl alcohol. Because the liquid detergent composition of the disclosure is self-preserved and does not contain, it can be manufactured at a wider range of pH. In other embodiments herein the liquid detergent composition comprises an inorganic pH adjusting agent such as e.g. NaOH. In some practices, the inorganic pH adjusting agent is present in an amount effective such that the final pH of the liquid detergent composition is about 8.5 to about 11.5 or higher.

Notably, in traditional laundry products the amount of surfactant is present in a range of from about 8 wt % to about 20 wt %. In contrast, in practices of the self-preserved concentrated liquid detergent of the disclosure, the amount of surfactant can be over 30 wt %. Such an amount of surfactant normally creates stability issues which are addressed in the practice of the disclosure by the inclusion of a non-aqueous solvent. And unlike traditional laundry products which contain a buffer, practices of the disclosure do not. By not using a buffer the self-preserved concentrated liquid detergent of the disclosure performs across a wide range of pH specifications which permit pH variations, e.g. of 1.5 to 2 pH units from the target pH, without detriment to performance. Moreover, as opposed to standard laundry products, the self-preserved concentrated liquid detergent of the present disclosure has a water activity level sufficiently low so that it is self-preserved, and which provides for reductions in shipping cost (due to there being less water to ship) and reductions in plastic waste.

### DETAILED DESCRIPTION

The entire contents of U.S. Published Patent Application No. 2018/0016523 are incorporated herein by reference for any purpose.

The present disclosure will now be described in greater detail by referring to the following discussion. In the following description, numerous specific details are set forth, such as particular structures, components, materials, dimensions, processing steps and techniques, in order to provide an understanding of the various embodiments of the present disclosure. However, it will be appreciated by one of ordinary skill in the art that the various embodiments of the present disclosure may be practiced without these specific details.

As used herein, the term “about” indicates that the value listed may be somewhat altered, as long as the alteration does not result in nonconformance of the method or system herein described. For example, for some elements the term “about” can refer to a variation of ±0.1%, for other elements, the term “about” can refer to a variation of ±0.1% to ±10%, or any point therebetween.

When a range is expressed in the present disclosure as being from one number to another number (e.g., 20 to 40), the present disclose contemplates any numerical value that is within the range (i.e., 22, 24, 26, 28.5, 31, 33.5, 35, 37.7, 39 or 40) and includes endpoints, fractional numbers, and whole numbers, and includes any amount that is bounded by any of the two values that can be present within the range (e.g., the range 20-40 includes 28.5-35).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, when used in this disclosure, specify the presence of stated features, integers, steps, operations, elements, and/or components, but do not preclude the presence or addition of one or more other features, integers, steps, operations, elements, components, and/or groups thereof

The self-preserved liquid detergent of the present disclosure can be used in non-unit dose form and comprises at least one non-aqueous solvent; at least one nonionic surfactant; at least one anionic surfactant; a C₂₋₃ alkanol; and water in an amount effective to produce a water activity of about 0.55 to about 0.8, wherein the liquid detergent composition does not contain any of the following (i) a preservative and (ii) a buffer.

Preservatives which are absent from the self-preserved liquid detergent composition include those known in the art such as without limitation isothiazolinones, including methylisothiazolinone, benzisothiazolinone, chloromethylisothiazolinone and the like. Buffers which are absent from the self-preserved liquid detergent composition include those known in the art such as without limitation monoethanolamine, triethylamine, and carbonates such as sodium carbonate.

In one embodiment, the liquid detergent composition comprises up to about 5 wt % LAS; or up to about 5 wt % PG; or up about 5 wt % LAS and separately up to about 5 wt % PG, based on the total weight of the liquid detergent composition. In one practice, the liquid detergent composition comprises about 0.05 wt % to about 1 wt % LAS, including e.g. about 0.1 wt % LAS. In one practice, the liquid detergent composition contains no LAS. In one practice, the liquid detergent composition comprises about 0.05 wt % to about 1 wt % PG, including e.g. about 0.1 wt % PG. In one practice, the liquid detergent composition contains no PG. In one preferred practice, the liquid detergent composition contains no LAS and no PG.

In one practice, the water in the concentrated liquid detergent composition can be derived from added water and water that accompanies a component that forms the raw material that is used in formulating the detergent composition. In the concentrated liquid detergent composition of the disclosure, water is present in an amount effective to provide a water activity of between about 0.55 to about 0.8. In other embodiments, the water activity is between about 0.65 to about 0.75; in other embodiments the water activity is between about 0.66 to about 0.7.

Water activity is a known measure of the freely available water in a material and indicates the availability of the water for chemical, biochemical, and microbial reactions. Water activity is stated as an “a_{w}” value and is defined as the quotient of the concentration of water in the vapor phase in the airspace over the liquid detergent composition and the water concentration in the airspace over pure water at a specific temperature, e.g. 25° C.: a_{w}=p/p₀.

In one practice, the total water amount present in the liquid detergent composition is present at about 10 wt % to about 30 wt %, including practices wherein water is present at about 15 wt % to about 25 wt %, and practices wherein water is present at about 20 wt %, as based on the total weight of the liquid detergent composition.

In one practice, the non-aqueous solvent comprises those known in the art, such as glycerin.

In various embodiments, of the self-preserved liquid detergent composition, the non-aqueous solvent is present at about 25 wt % to about 45 wt %; at about 30 wt % to about 40 wt %; and at about 35 wt %, based on the total weight of the liquid detergent composition.

Non-limiting examples of nonionic surfactants that can be employed in the present disclosure include alcohol ethoxylates (AE or AEO), alcohol propoxylates, propoxylated fatty alcohols (PFA), alkoxylated fatty acid alkyl esters, such as ethoxylated and/or propoxylated fatty acid alkyl esters, alkylphenol ethoxylates (APE), nonylphenol ethoxylates (NPE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), and combinations thereof. In some embodiments, the nonionic surfactant is an alcohol ethoxylate nonionic surfactant, such as a fatty alcohol ethoxylate C₁₂₋₁₅ 7EO.

In some embodiments of the self-preserved liquid detergent composition, the nonionic surfactant is present at about 20 wt % to about 40 wt %; at about 25 wt % to about 35 wt %; and at about 35 wt %, based on the total weight of the liquid detergent composition.

Non-limiting examples of anionic surfactants that can be employed in the present disclosure include sulfates and sulfonates, in particular, phenylalkanesulfonates, alpha-olefinsulfonates (AOS), olefin sulfonates, alkene sulfonates, alkane-2,3-diylbis(sulfates), hydroxyalkanesulfonates and disulfonates, alkyl sulfates (AS) such as sodium dodecyl sulfate (SDS), fatty alcohol sulfates (FAS), primary alcohol sulfates (PAS), alcohol ethersulfates (AES or AEOS or FES, also known as alcohol ethoxysulfates or fatty alcohol ether sulfates), secondary alkanesulfonates (SAS), paraffin sulfonates (PS), ester sulfonates, sulfonated fatty acid glycerol esters, alpha-sulfo fatty acid methyl esters (alpha-SFMe or SES) including methyl ester sulfonate (MES), alkyl- or alkenylsuccinic acid, dodecenyl/tetradecenyl succinic acid (DTSA), fatty acid derivatives of amino acids, diesters and monoesters of sulfo-succinic acid or salt of fatty acids (soap), or combinations thereof.

### LAS

In some embodiments of the self-preserved liquid detergent composition, the anionic surfactant is present at about 5 wt % to about 15 wt %; and at about 9 wt %, based on the total weight of the liquid detergent composition.

In some embodiments, the ratio of non-aqueous solvent to water (e.g. glycerin:water) is about 4:1 to about 1:1, including e.g. about 2:1. In some embodiments, the ratio of nonionic surfactant to anionic surfactant (e.g. alcohol ethoxylate:fatty alcohol ether sulfate) is about 8:1 to about 2:1, including about 3.5:1. In some embodiments, a lower amount of anionic surfactant can be used to promote mildness inasmuch as nonionic surfactants are often known to be generally milder.

The C₂₋₃ alkanol of the self-preserved liquid detergent composition includes those that are branched and linear such as ethanol and iso-propyl alcohol, including denatured. In some embodiments of the self-preserved liquid detergent composition, the C₂₋₃ alkanol is present at about 0.5 wt % to about 3 wt %, including about 1 wt % and about 1.5 wt %, based on the total weight of the liquid detergent composition.

In some embodiments, the self-preserved liquid detergent composition comprises a fatty acid compound, such as known in the art, including without limitation coconut fatty acid, palm kernel fatty acid and the like, and including those having the formula R—C(O)OH, wherein R is a C₅-C₂₁ linear or branched aliphatic group and combinations of fatty acid compounds. In some embodiments of the self-preserved liquid detergent composition, the fatty acid compound is present up to about 3 wt %, and in other embodiments the fatty acid is present at about 0.1 wt % to about 3 wt %, including about 0.2 wt % to about 1.0 wt %, based on the total weight of the liquid detergent composition.

In some embodiments, the self-preserved liquid detergent composition comprises an inorganic pH adjusting agent, such pH adjusting agents including those that increase the pH, i.e. are alkaline, and include those known in the art such as without limitation, sodium hydroxide (NaOH) and combinations of pH adjusting agents. In some embodiments of the self-preserved liquid detergent composition, the inorganic pH adjusting agent is present in an amount effective such that the self-preserved liquid detergent composition has a final pH of about 8.5 to about 11.5 or higher. In some embodiments of the self-preserved liquid detergent composition, the inorganic pH adjusting agent is present at about 0.05 wt % to about 0.7 wt %, including at about 0.1 wt % to about 0.5 wt %, including about 0.15 wt %, about 0.35 wt %, based on the total weight of the liquid detergent composition.

In addition to the above-mentioned components, the self-preserved liquid detergent composition of the present disclosure can include any additional detergent component(s) that is known in the art. Other optional detergent components include, for example, beaching systems, anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, CMC, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, and wicking agents, either alone or in combination, dye transfer agents, fluorescent whitening agents, soil release polymers, rheology modifiers or any combination thereof. Any component known in the art for use in detergents may be utilized. The choice of such optional components and the working amounts is well within the skill of the artisan. For example, the self-preserved liquid detergent composition can comprise component chelating agents, such as those known in the art, e.g. trisodium salt of methylglycinediacetic acid; microbiocides as known in the art; and performance polymers as known in the art, e.g. hydrophobically modified copolymers, ethoxylated polyethyleneimine polymers, and the like.

The self-preserved liquid detergent composition of the present disclosure can be formulated utilizing techniques well known to those skilled in the art. The various components that provide the detergent composition of the present disclosure can be added in any order. The addition of the various components that provide the detergent composition of the present disclosure can be performed with continuous stirring. The addition is typically performed at room temperature, e.g., from about 20° C. to about 30° C. In some embodiments, the self-preserved liquid detergent composition has a final pH of over 11.5, in other embodiments the pH is about 8.5 to about 11.5.

Examples have been set forth below for the purpose of further illustrating the present disclosure. The scope of the present disclosure is not limited to any of the examples set forth herein.

### Example 1

Concentrated self-preserved liquid detergent compositions according to the disclosure were prepared. The detergent compositions were prepared by mixing the components in the amounts listed in Table 1 in a standard overhead mixer.

In this Example 1, Formulas 4, 6, and 7 represent inventive practices of the present disclosure. In Formulas 4, 6, and 7, the non-aqueous solvent used to formulate the detergent compositions was glycerin, the nonionic surfactant was an alcohol ethoxylate, the anionic surfactant was a fatty alcohol ether sulfate, the C₂₋₃ alkanol was 200 proof denatured ethanol, and an inorganic pH adjusting agent was present, NaOH the weight percents for same varied to give the unit dose a final pH of 8.47, 10.11, and 11.5, respectively. No LAS, preservatives, propylene glycol, or buffers were used in these formulations.

In this Example 1, Formulas CE1, CE2, CE3, and CE5 are comparative. Differences with Inventive Formulas 4, 6, and 7 of the disclosure were as follows:

In Comparative Formula CE1, a non-aqueous solvent and a non-ionic surfactant were used (glycerin and the same alcohol ethoxylate as used in Inventive Formulas 4, 6, and 7; and 200 proof denatured ethanol), but no anionic surfactant or C₂₋₃ alkanol were present.

In Comparative Formula CE2, a non-aqueous solvent and a non-ionic surfactant and a C₂₋₃ alkanol were used (glycerin and the same alcohol ethoxylate as used in Inventive Formulas 4, 6, and 7; and 200 proof denatured ethanol), but no anionic surfactant was present.

In Comparative Formula CE3, a non-aqueous solvent and a non-ionic surfactant and an anionic surfactant were used (glycerin and the same alcohol ethoxylate and fatty alcohol ether sulfate as used in Inventive Formulas 4, 6, and 7), but no C₂₋₃ alkanol was present.

In Comparative Formula CE5, a non-ionic surfactant, an anionic surfactant, and a C₂₋₃ alkanol were used (the same alcohol ethoxylate and fatty alcohol ether sulfate but at a different wt % than that of the disclosure as used in Inventive Formulas 4, 6, and 7, and 200 proof denatured ethanol), but no non-aqueous solvent such as glycerin was present. Formula CE5 had a water activity of 0.9794 which was far higher than the water activities of Inventive Formulas 4, 6, and 7.

TABLE 1

| | Formula CE1 | Formula CE2 | Formula CE3 |
|---|---|---|---|
| Formula | (Comparative) | (Comparative) | (Comparative) |
| Buffer/Title | pH 8.5, no | pH 8.5, no | pH 8.5, no |
| | buffer | buffer | buffer |
| pH | 8.5 | 8.5 | 8.5 |
| SG | N/A | N/A | N/A |
| Viscosity | N/A | N/A | N/A |
| Water activity | N/A | N/A | N/A |
| Dose (g) | 18.74 g | 18.74 g | 18.74 g |
| Dose (fl oz) | 0.58 | 0.58 | 0.58 |
| Concentration | 2.6x | 2.6x | 2.6x |
| (1x = 1.5 fl oz) | | | |
| g surfactant | 6.87 | 6.87 | 6.87 |
| per dose | | | |
| Stability | Not Stable | Not Stable | Not Stable |
| | After Mixing | After Mixing | After Mixing |
| Description | Only Non- | Only Non- | Anionic/Non- |
| | ionic | ionic | ionic |
| | surfactant, | surfactant | Surfactant Blend, |
| | No Ethanol | with Ethanol | no Ethanol |

| | Active Level | | | |
|---|---|---|---|---|
| Ingredient | % | wt % | wt % | wt % |
| Glycerin | 100 | 39.01 | 37.51 | 37.39 |
| Alcohol Exthoxylate | 100 | 36.66 | 36.66 | 30.36 |
| Nonionic Surfactant | | | | |
| Sodium Lauryl | 70 | 0 | 0 | 9 |
| Ether Sulfated | | | | |
| Anionic Surfactant | | | | |
| 20% Na-Carbonate | 20 | 0 | 0 | 0 |
| Solution | | | | |
| Water | 100 | 21.24 | 21.24 | 20.16 |
| Coconut Fatty Acid | 100 | 1 | 1 | 1 |
| 200 Proof Ethanol | 100 | 0 | 1.5 | 0 |
| Denatured | | | | |
| Trisodium Salt of | 40 | 1.94 | 1.94 | 1.94 |
| methylglycinediacetic | | | | |
| acid | | | | |
| NaOH | 50 | 0.15 | 0.15 | 0.15 |
| Palm Kernel Fatty | 100 | 0 | 0 | 0 |
| Acid | | | | |
| Ethoxylated | 78.7 | 0 | 0 | 0 |
| Polyethyleneimine | | | | |
| Polymer | | | | |
| Hydrophobically | 37 | 0 | 0 | 0 |
| Modified | | | | |
| Copolymer | | | | |
| Microbiocide | 20 | 0 | 0 | 0 |
| Total | | 100 | 100 | 100 |

| | Formula 4 | Formula CE5 |
|---|---|---|
| Formula | (Inventive) | (Comparative) |
| Buffer/Title | pH 8.5, no | 2x- |
| | buffer | Control |
| pH | 8.47 | 10.92 |
| SG | 1.10 | 1.03 |
| Viscosity | 329 | 471 |
| Water activity | 0.67 | 0.98 |
| Dose (g) | 18.74 g | 22.77 g |
| Dose (fl oz) | 0.58 | 0.75 |
| Concentration | 2.6x | 2x |
| (1x = 1.5 fl oz) | | |
| g surfactant | 6.87 | 4.75 |
| per dose | | |
| Stability | Stable for 1+ | Stable for 1+ |
| | month | month |
| Description | Anionic/Non- | Bench Mark |
| | ionic Surfactant | |
| | Blend, | |
| | with Ethanol | |

| | Active Level | | |
|---|---|---|---|
| Ingredient | % | wt % | wt % |
| Glycerin | 100 | 35.89 | 0 |
| Alcohol Exthoxylate | 100 | 30.36 | 13.92 |
| Nonionic Surfactant | | | |
| Sodium Lauryl | 70 | 9 | 9.943 |
| Ether Sulfated | | | |
| Anionic Surfactant | | | |
| 20% Na-Carbonate | 20 | 0 | 2.5 |
| Solution | | | |
| Water | 100 | 20.16 | 65.98 |
| Coconut Fatty Acid | 100 | 1 | 0 |
| 200 Proof Ethanol | 100 | 1.5 | 1.5 |
| Denatured | | | |
| Trisodium Salt of | 40 | 1.94 | 4 |
| methylglycinediacetic | | | |
| acid | | | |
| NaOH | 50 | 0.15 | 0 |
| Palm Kernel Fatty | 100 | 0 | 0.28 |
| Acid | | | |
| Ethoxylated | 78.7 | 0 | 0.65 |
| Polyethyleneimine | | | |
| Polymer | | | |
| Hydrophobically | 37 | 0 | 1.08 |
| Modified Copolymer | | | |
| Microbiocide | 20 | 0 | 0.15 |
| Total | | 100 | 100 |

| | Formula 6 | Formula 7 |
|---|---|---|
| Formula | (Inventive) | (Inventive) |
| Buffer/Title | pH 10.5, no | pH 11.5, no |
| | buffer | buffer |
| pH | 10.11 | 11.55 |
| SG | 1.10 | 1.10 |
| Viscosity | 336 | 300 |
| Water activity | 0.67 | 0.67 |
| Dose (g) | 18.74 g | 18.74 g |
| Dose (fl oz) | 0.58 | 0.58 |
| Concentration | Stable for 1+ | Stable for 1+ |
| (1x = 1.5 fl oz) | month | month |
| g surfactant per | 6.87 | 6.87 |
| dose | | |
| Stability | Anionic/Non- | Anionic/Non- |
| | ionic Surfactant | ionic Surfactant |
| | Blend, | Blend, |
| | with Ethanol | with Ethanol |
| Description | Stable for 1+ | Stable for 1+ |
| | month | month |

| | Active Level | | |
|---|---|---|---|
| Ingredient | % | wt % | wt % |
| Glycerin | 100 | 35.69 | 35.54 |
| Alcohol Exthoxylate | 100 | 30.36 | 30.36 |
| Nonionic Surfactant | | | |
| Sodium Lauryl | 70 | | 9 |
| Ether Sulfated | | | |
| Anionic Surfactant | | | |
| 20% Na-Carbonate | 20 | | 0 |
| Solution | | | |
| Water | 100 | 6 | 20.16 |
| Coconut Fatty Acid | 100 | | 1 |
| 200 Proof Ethanol | 100 | .5 | 1.5 |
| Denatured | | | |
| Trisodium Salt of | 40 | .94 | 1.94 |
| methylglycinediacetic | | | |
| acid | | | |
| NaOH | 50 | .35 | 0.50 |
| Palm Kernel Fatty | 100 | | 0 |
| Acid | | | |
| Ethoxylated | 78.7 | | 0 |
| Polyethyleneimine | | | |
| Polymer | | | |
| Hydrophobically | 37 | | 0 |
| Modified Copolymer | | | |
| Microbiocide | 20 | | 0 |

As shown in Table 1, Comparative Formulas CE1, CE2, and CE3 formed a clear phase separation after mixing whereas inventive Formulas 4, 6, and 7, which all comprised a non-aqueous solvent, a nonionic surfactant, an anionic surfactant, and a C₂₋₃ alkanol, were stable after mixing and continued to be stable for at least one month at temperatures of −29° C., 4.5° C., 24° C. and 40.5° C., as well as for at least one week at 51.7° C. Inventive Formulas 4, 6 and 7 were also found to be stable if formulated with 1 wt % ethanol instead of 1.5 wt % shown.

Water activity, a_{w}=p/p₀, was determined at 25° C. Target water activity in this Example 1 was below 0.7. This was achieved using a ratio of glycerin to water of about 36:20. As seen in Table 1, water activity as measured for Formulas 4, 6, and 7 and were 0.6656, 0.6686, and 0.6669, respectively. If a water activity of 0.7 or lower is desired, then a higher ratio of glycerin to water would be used; if a water activity of 0.8 or more is desired, then a higher ratio of water can be used.

### Example 2

Formulas 4, 6, and 7 of the disclosure were tested for stain removal performance against a variety of stains (about 18.8 grams of Inventive Formulas 4, 6, and 7 and about 22.8 grams of Formula CE5). Product A was a bench mark commercial liquid detergent product. Approximately 10 different stains, including blood, chocolate ice cream, coffee, grape juice, grass, and mud, were tested on knitted cotton and polyester fabric using a high efficiency top-loader with wash water at about 59° F. (cold water wash) and about 90° F. (warm water wash) and wins/losses (W/L) representing acceptable stain removal and unacceptable stain removal were observed. The results are shown in Table 2.

TABLE 2

| | | | W/L vs. 2x | W/L vs. 2x |
|---|---|---|---|---|
| | | SLES per dose | Product A | Product A |
| | | Compared to | (Formula CE5) | (Formula CE5) |
| | Formula | Product A 1x | 59F | 90F |
| No | pH 8.5 | 50% Reduction | 1 | 1 |
| Buffer | (Formula 4) | | | |
| | pH 10 | 50% Reduction | 2 | 3 |
| | (Formula 6) | | | |
| No | pH 11.5 | | | |
| Buffer | (Formula 7) | 50% Reduction | 0 | 4 |

### Example 3

Inventive Formulas 4, 6, and 7 were tested for Zein scores at 10% dilution (standard for a liquid detergent) and at 3% dilution (standard for unit dose detergents). The 3% dilution was performed inasmuch as Formula 4 had an approximate concentration to a unit dose detergent. The Zein test measures the skin irritancy potential of a surfactant composition. Zein scores are known in the art, as disclosed e.g. in U.S. Published Patent Application No. 2018/0016523. The Zein test determines the extent of denaturation of Zien corn protein after exposure to a surfactant for a given period of time. Generally, the higher the Zein score, the greater the skin irritation potential. The results are shown in Table 3.

TABLE 3

| Product | Dilution | Zein % |
|---|---|---|
| Product A 2x | 10% | 1.69 |
| (Formula CE5) | 3% | 0.39 |
| pH 8.5 | 10% | 2.7 |
| (Formula 4) | 3% | 0.91 |
| (2.6x) | | |
| pH 11.5 | 10% | 2.72 |
| (Formula 7) | 3% | 0.88 |
| (2.6x) | | |

As seen in Table 3, all scores were below 2% Zein dissolved at 3% dilution, which is indicative of a mild formulation.

As seen from the data herein, the self-preserved liquid detergent composition of the disclosure as exemplified by Inventive Formulas 4, 6, and 7 deliver the same amount of surfactant as Product A 1× per dose to the washing machine (6.87 grams per wash) whereas Comparative Formula CE5 did not deliver the same amount of active surfactant as Product A 1× and utilized higher levels of chelating agent and performance polymers. Inventive Formulas 4, 6, and 7 representing the disclosure also good stability and performance which indicates a wide manufacturing specification range of pH may be employed as opposed to the narrower pH range generally needed for quality control in detergents containing preservatives.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

What is claimed is:

1. A self-preserved liquid detergent composition comprising:
at least one non-aqueous solvent;
at least one nonionic surfactant;
at least one anionic surfactant;
a C₂₋₃ alkanol; and
water in an amount effective to produce a water activity of about 0.55 to about 0.8, wherein the liquid detergent composition does not contain any of the following (i) a preservative and (ii) a buffer.

2. The self-preserved liquid detergent composition of claim 1 wherein the at least one non-aqueous solvent comprises glycerin.

3. The self-preserved liquid detergent composition of claim 1 wherein the at least one nonionic surfactant comprises an alcohol ethoxylate, an alcohol propoxylate, a propoxylated fatty alcohol, an alkoxylated fatty acid alkyl ester, an alkylphenol ethoxylate, a nonylphenol ethoxylate, an alkylpolyglycoside, an alkoxylated amine, a fatty acid monoethanolamide, a fatty acid diethanolamide, an ethoxylated fatty acid monoethanolamide, a propoxylated fatty acid monoethanolamide, a polyhydroxyalkyl fatty acid amide, a N-acyl N-alkyl derivative of glucosamine, or combinations thereof.

4. The self-preserved liquid detergent composition of claim 3 wherein the nonionic surfactant comprises an alcohol ethoxylate.

5. The self-preserved liquid detergent composition of claim 1 wherein the at least one anionic surfactant comprises a phenylalkanesulfonate, an alpha-olefinsulfonate, an olefin sulfonate, an alkene sulfonate, an alkane-2,3-diylbis(sulfate), a hydroxyalkanesulfonate or disulfonate, an alkyl sulfate, a fatty alcohol sulfate, a primary alcohol sulfate, an alcohol ether sulfate, a fatty alcohol ether sulfate, a secondary alkanesulfonate, a paraffin sulfonate, an ester sulfonate, a sulfonated fatty acid glycerol ester, an alpha-sulfo fatty acid methyl ester, an alkyl- or alkenylsuccinic acid, a dodecenyl/tetradecenyl succinic acid, a fatty acid derivative of amino acid, a diester or monoester of sulfo-succinic acid, or combinations thereof.

6. The self-preserved liquid detergent composition of claim 5 wherein anionic surfactant comprises a fatty alcohol ether sulfate.

7. The self-preserved liquid detergent composition of claim 1 wherein the C₂₋₃ alkanol comprises ethanol.

8. The self-preserved liquid detergent composition of claim 1 wherein the water activity is about 0.66 to about 0.7.

9. The self-preserved liquid detergent composition of claim 1 wherein the water is present at about 15 wt % to about 25 wt % based on the total weight of the liquid detergent composition.

10. The self-preserved liquid detergent composition of claim 1 wherein the non-aqueous solvent is present at about 25 wt % to about 45 wt % based on the total weight of the liquid detergent composition.

11. The self-preserved liquid detergent composition of claim 1 wherein the nonionic surfactant is present at about 20 wt % to about 40 wt % based on the total weight of the liquid detergent composition.

12. The self-preserved liquid detergent composition of claim 1 wherein the anionic surfactant is present at about 5 wt % to about 15 wt % based on the total weight of the liquid detergent composition.

13. The self-preserved liquid detergent composition of claim 1 wherein the C₂₋₃ alkanol is present at about 0.5 wt % to about 3 wt % based on the total weight of the liquid detergent composition.

14. The self-preserved liquid detergent composition of claim 1 further comprising one or more fatty acid compounds.

15. The self-preserved liquid detergent composition of claim 14 wherein the fatty acid compounds are selected from coconut fatty acid, palm kernel fatty acid, or both.

16. The self-preserved liquid detergent composition of claim 1 further comprising an inorganic pH adjusting agent.

17. The self-preserved liquid detergent composition of claim 16 wherein the inorganic pH adjusting agent is present in an amount sufficient such that the liquid detergent composition has a final pH of about 8.5 to about 11.5.

18. The self-preserved liquid detergent composition of claim 1 wherein, based on the total weight of the liquid detergent composition, the non-aqueous solvent is present at about 25 wt % to about 45 wt %; the nonionic surfactant is present at about 20 wt % to about 40 wt %; the anionic surfactant is present at about 5 wt % to about 15 wt %; the C₂₋₃ alkanol is present at about 0.5 wt % to about 3 wt %; and the water is present at about 15 wt % to about 25 wt %.

19. The self-preserved liquid detergent composition of claim 1 wherein the self-preserved liquid detergent composition contains no linear alkylbenzene sulfonates and no propylene glycol.

20. The self-preserved liquid detergent composition of claim 1 further comprising (a) up to about 5 wt % of a linear alkylbenzene sulfonate; or (b) up to about 5 wt % of propylene glycol; or (c) up to about 5 wt % of a linear alkylbenzene sulfonate, and separately up to about 5 wt % of propylene glycol, based on the total weight of the liquid detergent composition.
